(19) United States
(12) Patent Application Publication
(10) Pub. No.: US 2025/0369644 A1
(43) Pub. Date: Dec. 4, 2025

(54) FAN SPEED CONTROL DEVICE

(71) Applicant: Nibrotech Limited, Worcester, Worcestershire (GB)

(72) Inventor: Richard James CORBIN, Worcester (GB)

(21) Appl. No.: 18/869,730

(22) PCT Filed: May 25, 2023
(86) PCT No.: PCT/GB2023/051373

§ 371 Date: Nov. 26, 2024

(30) Foreign Application Priority Data
May 27, 2022 (GB) 2207840.6

(51) Int. Cl. F24F 11/77; F24F 11/58; F24F 110/10

(52) U.S. Cl. CPC F24F 11/77; F24F 11/58; F24F 2110/10

(57) ABSTRACT

There is provided a fan speed control device for controlling a fan speed of a fan, the fan speed control device comprising: a power input configured for connection to a power source to receive power from the power source; a power output configured for detachable connection to the fan to supply power to the fan; a data receiver module configured to, in use, receive sensor data from a sensor; and a power modulator configured to, in use, control the fan speed of the fan by modulating a supply of power to the fan in response to the received sensor data.

### CROSS-REFERENCE TO RELATED APPLICATIONS

This application is a U.S. national phase application filed under 35 U.S.C. § 371 of International Application Number PCT/GB2023/051373, filed May 25, 2023, designating the United States, which claims priority from United Kingdom Patent Application Number GB 2207840.6, filed May 27, 2022, both of which are hereby incorporated by reference herein in their entireties.

### FIELD

This disclosure relates to a fan speed control device, preferably for use with single-phase AC fans.

### BACKGROUND

It is known to operate a fan at different fan speeds depending on user preference.

### SUMMARY

According to a first aspect of this disclosure, there is provided a fan speed control device for controlling a fan speed of a fan, the fan speed control device comprising:
a power input configured for connection to a power source to receive power from the power source;
a power output configured for detachable connection to the fan to supply power to the fan;
a data receiver module configured to, in use, receive sensor data from a sensor; and
a power modulator configured to, in use, control the fan speed of the fan by modulating a supply of power to the fan in response to the received sensor data.

A fan speed control device having the above features is capable of effectively transforming a standard “dumb” fan, i.e. a fan lacking integral technology capable of communicating with sensors, into a smart fan that is capable of dynamically adjusting its fan speed to track and meet a user's needs without manual user operation. The use of the fan speed control device can therefore increase a user's comfort by providing a standard fan with sensor-driven adaptive fan speed control that is automatically responsive to received sensor data.

Moreover the fan speed control device is capable of being retrofitted to a wide range of standard fans, thus providing users with a cost-effective solution for enhancing the capabilities of their existing fans. In particular, due to the configuration of the fan speed control device as an external device to the fan, the fan speed control device can be easily disconnected from a fan, transported to a new site, and reused in combination with other fans. The fan speed control device therefore provides a user with greater cost savings and flexibility compared to smart fans.

The device of this disclosure is applicable in a wide range of industries, such as the sports, fitness, healthcare, medical, farming and animal welfare industries.

In a preferred embodiment, the power output may be configured for detachable connection to a power connector of the fan. The power output may include a socket for detachably receiving a power connector of the fan. The power output being configured for detachable connection to a power connector of the fan allows for easy connection and disconnection between the fan speed control device and the fan. The power output including a socket for detachably receiving a power connection, e.g. a plug, of the fan is particularly advantageous for the ease of connection and disconnection of the fan speed control device and the fan. As a result, a user would not be required to modify their fan in order to enable connection with the fan speed control device because they can simply use the power connector of the fan to connect to the fan speed control device.

It will be appreciated that the power output may include any type of electrical connector that enables its detachable connection to the fan to supply power to the fan.

In some embodiments, the power input may be configured for connection to a mains power source. The fan speed control device comprising a power input configured for connection to a mains power source advantageously provides a simple arrangement to provide reliable power to the fan speed control device and to the fan itself. In alternative embodiments, the power input may be configured for connection to a battery, a power generator or another type of power source.

In some embodiments, the fan speed control device may further comprise a housing that houses at least the data receiver module and the power modulator. The provision of a housing to house at least the data receiver module and the power modulator ensures that critical components of the fan speed control device are protected from damage but also enables a compact size of the fan speed control device. Other components of the fan speed control device, such as the power output and the power input, can, but are not required to, be provided outside the housing. Therefore, the fan speed control device may comprise a housing that at least partially houses the power input and power output. This arrangement would result in a fan speed control device that is more compact overall and more convenient for transport.

In some embodiments, the sensor data may comprise heart rate data, and the data receiver module may be configured to, in use, receive the heart rate data from a heart rate sensor. The sensor data comprising heart rate data advantageously provides the fan speed control device with a reliable indication of a user's physical or physiological condition since the user's heart rate provides information about their general health, exercise load, energy levels and exhaustion levels. This data can be advantageously used to modify the fan speed to match and improve the user's physical or physiological condition. For example, the fan speed may be increased if the received heart rate data indicates a rise in heart rate, and the fan speed may be decreased if the received heart rate indicates a drop in heart rate. This is because heart rate is generally proportional to exercise load and hence cooling requirement.

The heart rate sensor may preferably be a wearable heart rate sensor such as a heart rate watch or a heart rate monitor strap. Such a wearable sensor provides consistent and reliable heart rate data. Alternatively, the heart rate sensor may be integrally or detachably part of an exercise equipment.

In further embodiments, the sensor data may comprise temperature data, and the data receiver module may be configured to, in use, receive the temperature data from a temperature sensor. The sensor data comprising temperature data advantageously provides the fan speed control device with a reliable indication of the user's body temperature, such as a fever or a low/high temperature, which can affect the user's performance or health. This data can be advantageously used to modify the fan speed to match and improve a user's physical or physiological condition.

In some embodiments, the sensor data may comprise exercise data, and the data receiver module may be configured to, in use, receive the exercise data from an exercise sensor. An exercise sensor may be any type of exercise sensor that tracks a user's exercise, such as a pedometer or an accelerometer, capable of measuring a user's movements (e.g. walking, jogging, running, jumping, cycling, rowing). The sensor data comprising exercise data from an exercise sensor advantageously provides the fan speed control device with information on the exercise carried out by a user which is linked to their physical exertion. This information can be advantageously used to modify the fan speed to match and improve a user's physical condition during exercise or recovery.

In further embodiments, the sensor data may comprise exercise data, and the data receiver module may be configured to, in use, receive the exercise data from an exercise equipment sensor. Many different types of exercises are carried out using exercise equipment such as a treadmill, a stationary bike, a turbo trainer or a rowing machine, many of which comprise exercise equipment sensors. The sensor data comprising exercise data from an exercise equipment sensor advantageously provides the fan speed control device with information indicative of a user's physical exertion. This information can be advantageously used to modify the fan speed to match and improve a user's physical condition during exercise or recovery.

The exercise data may include at least one of exercise resistance level data, user power data and user speed data. Such exercise data advantageously provide information that facilitates a more accurate estimation of a user's expended energy and physical exertion during exercise.

In some embodiments, the fan speed control device may further comprise an ambient temperature sensor, and wherein the power modulator may be configured to, in use, control the fan speed of the fan in response to ambient temperature data measured by the ambient temperature sensor. Ambient temperature affects the temperature regulation of the body and will therefore affect the cooling effect provided by a fan at a given speed. The fan speed control device further comprising an ambient temperature sensor advantageously allows the fan speed control device to automatically adjust the fan speed of the fan in relation to the ambient temperature to ensure suitable cooling of the user.

In some embodiments, the data receiver module may be configured to, in use, receive configuration settings data, and the power modulator may be configured to, in use, control the fan speed of the fan by modulating the supply of power to the fan in accordance with the configuration settings data. These features enable the fan speed control device to control the fan speed of the fan in a way that is tailored to a user's preferences and/or requirements. The fan speed control device is therefore able to use the received sensor data more effectively within the context provided by the configuration settings data.

In further embodiments, the fan speed control device may further comprise a data memory module configured to, in use, store configuration settings data of the power modulator. Optionally default configuration settings data (i.e. factory settings) may be stored in the data memory module. Optionally the data memory module may be configured to, in use, replace stored configuration settings data with new configuration settings data when the data receiver module receives the new configuration settings data. The fan speed control device comprising such a data memory module allows the configuration settings data of the fan speed control device to be updated, e.g. by a user. This advantageously allows the user to improve the accuracy of the configuration settings data and/or update the configuration settings data following a change in their physical condition or requirements, e.g. improved stamina, an injury, etc. This feature also advantageously allows multiple users to make use of the same fan speed control device with personalised configuration settings data, where the configuration settings data in the data memory module is updated whenever a new user profile is loaded.

The configuration settings data may include at least one of user heart rate zone data, maximum heart rate data, threshold heart rate data and resting heart rate data. The configuration settings data may include at least one of user power zone data and threshold user power data. These types of data provide information indicative of a user's physical endurance and stamina, and can therefore be used to interpret the received sensor data. This in turn enables the fan speed control device to enhance its control over the fan speed of the fan in accordance with the received sensor data relative to the user's physical endurance and stamina.

The configuration settings data may include time delay data, and the time delay data may include a time delay for delaying the power modulator's control of the fan speed of the fan by modulating the supply of power to the fan in response to the received sensor data. The configuration settings data including time delay data advantageously allows for the fan speed control device to provide a more consistent control of the fan speed of the fan. For example if a user stops intensely exercising and intends to have a short recovery period before restarting, the time delay allows the fan speed control device to ignore the temporary change in exercise data (e.g. user power data) since the user still requires cooling and will require cooling once they resume exercising therefore avoiding highly fluctuating fan speeds. Conversely, without the time delay, there is a risk of the user being temporarily exposed to unsuitable fan speeds.

The configuration settings data may include fan speed intensity data, and the fan intensity data may include a multiplier value for amplifying or de-amplifying the fan speed of the fan controlled by the power modulator by modulating the supply of power to the fan in response to the received sensor data. The provision of the fan speed intensity data in the configuration settings data enables the fan speed of the fan to be controlled to feel more fluid to a user.

In some embodiments, the power modulator may be configured to, in use, modify the fan speed of the fan by modulating the supply of power to the fan in response to a change in parameter of the received sensor data. This allows the fan speed control device to dynamically vary the fan speed of the fan in response to changes in the received sensor data. This enables the fan speed control device to continuously and autonomously provide an optimum fan speed without manual user input. This is particularly useful when a user cannot easily reach the fan or the fan speed control device, e.g. when they are bedbound or using an exercise equipment at a distance from the fan and/or the fan speed control device.

The power modulator may be configured to, in use, control the fan speed of the fan by modulating the supply of power to the fan so that the fan is controlled to switch between a first fan speed and a different, second fan speed for a predetermined time duration. Configuring the fan speed control device in this manner advantageously not only enables the optimisation of the fan speed control to suit changing user requirements during the predetermined time duration but also be used to limit the maximum cooling effect provided to a user and avoid potential detrimental health effects to the user as well as saving energy.

In further embodiments, the data receiver module may be configured to, in use, receive the sensor data from the sensor via wireless communication. Such configuration of the data receiver module advantageously permits the fan speed control device to be used in different situations and environments without requiring wired connections, and thereby does not encumber the movement of a user, but also facilitates its communication with multiple sensors. Additionally or alternatively, the data receiver module may be configured to, in use, receive sensor data from the sensor via wired communication. This may be particularly advantageous for receiving sensor data from exercise equipment sensors or temperature sensors, where a wired connection ensures reliable connection between the sensor and the fan speed control device.

The data receiver module may be configured to, in use, communicate with the sensor via a first wireless communication protocol and communicate with a user input device via a different, second wireless communication protocol, and the data receiver module may be configured to, in use, switch between the first and second wireless communication protocols. The provision of this feature allows the data receiver module to save energy by using the most energy efficient communication protocol for the task required at any given time.

According to a second aspect of this disclosure, there is provided an apparatus comprising:
a fan speed control device according to any one of the preceding embodiments; and
a user input device configured to be in communication with the data receiver module of the fan speed control device, wherein the user input device is configured to permit user input of configuration settings data for transmission to the data receiver module.

The features and advantages of the fan speed control device of the first aspect of this disclosure and its embodiments apply mutatis mutandis to the apparatus of the second aspect of this disclosure and its embodiments.

Preferably the user input device may be a mobile electronic device. The mobile electronic device may be any one of a mobile phone, a tablet or any other mobile electronic device. The mobile electronic device may be configured to accept user inputs using a software application (or commonly known as an “app”). This advantageously allows a user to control the fan speed control device using their personal mobile electronic device in which their profile is stored.

It will be appreciated that the use of the terms “first” and “second”, and the like, in this patent specification is merely intended to help distinguish between similar features, and is not intended to indicate the relative importance of one feature over another feature, unless otherwise specified.

Within the scope of this patent application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Preferred embodiments will now be described, by way of non-limiting examples, with reference to the accompanying drawings in which:

FIG. 1 shows a fan speed control device according to an embodiment of this disclosure;

FIG. 2 shows the fan speed control device of FIG. 1 in more detail;

FIG. 3 shows a step-by-step process of a set-up of the fan speed control device according to an embodiment of this disclosure; and

FIG. 4 shows an interaction between components of the fan speed control device and a mobile electronic device.

The figures are not necessarily to scale, and certain features and certain views of the figures may be shown exaggerated in scale or in schematic form in the interests of clarity and conciseness.

### DETAILED DESCRIPTION

While doing strenuous physical exercise in a warm room with minimal air flow, a user faces two problems: how to keep cool, and how to get enough fresh air. Conventionally users employ a standard fan, which may be of the pedestal, desk or floor type. The fan is turned on prior to exercise. However it is very difficult to alter the fan speed during exercise because the fan is required to be at a minimum distance from the user during exercise and because changing the fan speed settings would disrupt the user's exercise.

As a consequence, the user is left with a far from ideal situation where the fan speed can only be correct for a narrow range of exercise effort. A high exercise effort session might result in the user feeling too hot, while a low exercise effort session might result in the user feeling too cold. A deviation of a few degrees on either side of the body's normal core temperature can dramatically affect the user's performance and sometimes adversely affect the user's health in extreme situations.

Most conventional fans are not capable of cooling an adult working at their VO2 max, particularly if the fan is set to a low power in order to prevent the user from experiencing chills when conducting easy intervals. The lack of cooling power and the inability to adjust the fan cooling “on-the-fly” will cause the athlete to become hot and most likely induce sweating. Excessive heat build-up in these circumstances can lead to loss of performance and dehydration.

The device according to this disclosure provides a solution that enables users to exercise indoors while staying comfortable for greater portions of their exercise time. Furthermore, the device according to this disclosure may enable the user to perform at higher levels due to improved body core temperature regulation, which in turn provides a more enjoyable and productive exercise experience.

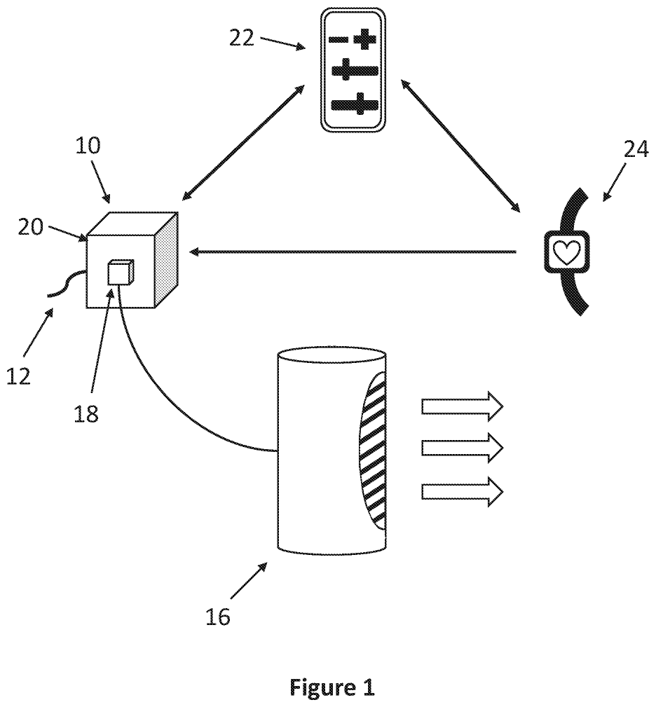

A fan speed control device is described with reference to FIG. 1 and is designated generally by the reference numeral 10.

The fan speed control device 10 comprises a power input 12, exemplarily shown as a cable, connected to a power source via a plug (not shown) to receive power from the power source. The power source is preferably a mains power source, which may be rated at 110-250 V AC power.

The fan speed control device 10 comprises a power output 14 that is detachably connected to a fan 16 to, in use, supply power to the fan 16. More specifically the power output 14 is a socket that receives a power connector 18, e.g. a plug, of the fan 16.

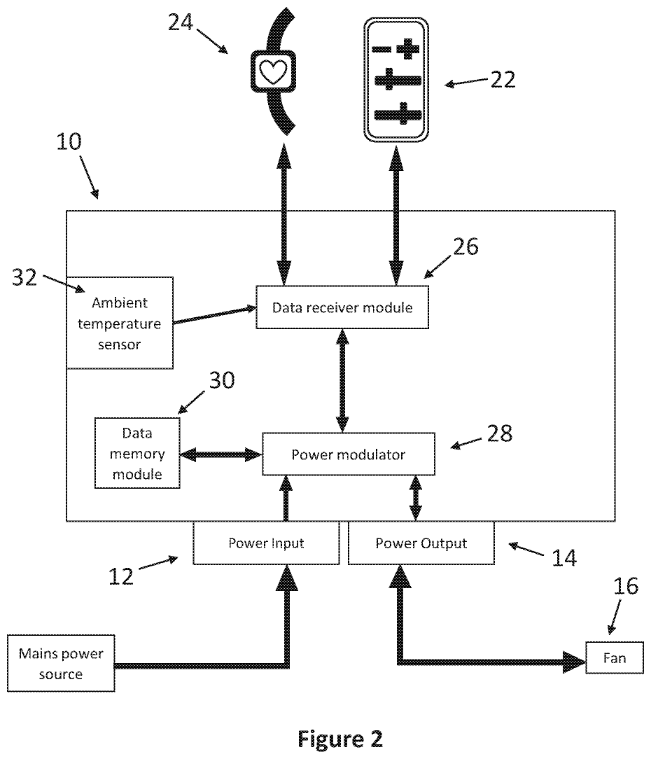

The fan speed control device 10 comprises a housing 20 that houses a plurality of components shown in more detail in FIG. 2.

The fan speed control device 10 is configured to communicate wirelessly with a user input device 22 that is exemplarily a mobile electronic device, such as a smartphone or a smartwatch. The mobile electronic device 22 is configured to permit user input of configuration settings data for transmission to the fan speed control device 10. Such user input can be carried out using an app.

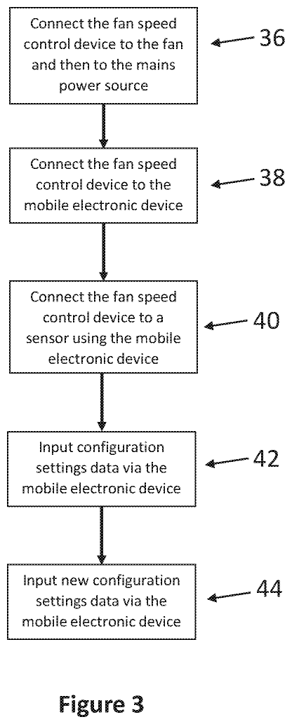

The mobile electronic device 22 also may act as an intermediary to connect the fan speed control device 10 to a sensor, such as a heart rate sensor 24 and an exercise equipment sensor (not shown), as described in relation to FIG. 3 further below.

The heart rate sensor 24 is a wearable heart rate sensor. The fan speed control device 10 is configured to receive heart rate data from the heart rate sensor 24. The exercise equipment sensor is an integral sensor that is part of an exercise equipment, e.g. a turbo trainer. The fan speed control device 10 is configured to receive exercise data from the exercise equipment sensor. The exercise data includes at least one of exercise resistance level data, user power data and user speed data.

In other embodiments, the fan speed control device may be configured to receive temperature data from a temperature sensor (not shown) such as digital or infrared thermometers. The fan speed control device may additionally or alternatively be configured to receive exercise data from an exercise sensor (not shown) such as a pedometer or an accelerometer.

The fan speed control device 10 is shown in more detail in FIG. 2. The fan speed control device 10 houses a data receiver module 26 configured to, in use, receive sensor data. The fan speed control device 10 also houses a power modulator 28 configured to, in use, control the fan speed of the fan 16 by modulating a supply of power to the fan 16 in response to the received sensor data. The power modulator 28 comprises control electronics. The fan speed control device 10 further houses a data memory module 30 configured to, in use, store configuration settings data of the power modulator 28. The data receiver module 26, the power modulator 28 and the data memory module 30 are, for example, comprised in a microcontroller and an AC controller.

In use, the fan speed control device 10 is connected to the mains power source via the power input 12, and the power modulator 28 is configured to modulate the supply of power to the fan 16 via the power output 14. The power modulator 28 can supply any amount of power to the fan ranging from 0% to 100% of the power provided by the mains power source. In addition the power modulator 28 can supply the fan with a variable power over a predefined time duration.

In use, the data receiver module 26 is configured to receive sensor data that comprises heart rate data from the heart rate sensor 24 and exercise data from the exercise equipment sensor. The data receiver module 26 is configured to, in use, additionally receive sensor data from one or more internal sensors that are at least partially housed in the housing 20. The one or more internal sensors include an ambient temperature sensor 32, which measures ambient temperature.

The communication between the data receiver module 26 and each of the heart rate sensor 24, the exercise equipment sensor and the mobile electronic device 22 is wireless. The communication between the data receiver module 26 and each of the heart rate sensor 24 and the exercise equipment sensor is conducted through ANT protocol. The communication between the data receiver module 26 and the mobile electronic device 22 is conducted through Bluetooth Low Energy (BLE) protocol. The data receiver module 26 is configured to, in use, switch between the ANT and BLE protocols in order to switch between communication with the sensors 24 and communication with the mobile electronic device 22. Other wireless communication protocols may be used in other embodiments.

The communication between the data receiver module 26 and the ambient temperature sensor 32 is wired. The ambient temperature sensor 32 is thermally insulated from other components housed in the housing 20 to prevent interference with its sensor readings.

An example set-up process of the fan speed control device 10 is summarised in FIG. 3.

In use, the fan speed control device 10 is first connected to the fan 16 via the power output 14 before being connected to the mains power source via the power input 12, as shown in step 36. The mains power source powers the aforementioned electronic components of the fan speed control device 10, thus allowing the fan speed control device 10 to be turned on. This sequence allows the fan speed control device 10 to provide a voltage pulse to the fan 16 to trigger a brief fan movement, which enables a user to check whether the fan speed control device 10 and the fan 16 are properly connected to each other.

The fan speed control device 10 is then connected via BLE protocol to the mobile electronic device 22, as shown in step 38. The user is subsequently able to use the mobile electronic device 22 to pair the data receiver module 26 to the heart rate sensor 24 and the exercise equipment sensor, as shown in step 40. Once the data receiver module 26 is paired to the heart rate sensor 24 and the exercise equipment sensor, it can communicate with each of them via ANT protocol without requiring the use of the mobile electronic device 22. In other embodiments, the data receiver module 26 may be configured to receive data from the sensors 24 via the mobile electronic device 22.

The data receiver module 26 then receives configuration settings data from the mobile electronic device 22, as shown in step 42. The configuration settings data may be manually inputted by a user, or may be extracted from data (e.g. a user profile) saved in the mobile electronic device 22. The configuration settings data is then saved in the data memory module 30.

Once the data receiver module 26 has received the configuration settings data, the fan speed control device 10 is ready for use to control the fan speed of the fan 16.

If the data receiver module 26 receives new configuration data via the mobile electronic device 22, as shown in step 44, the data memory module 30 replaces the stored configuration settings data with the new configuration settings data.

In other embodiments, the set-up of the fan speed control device may be different. It will be appreciated that the steps of the process is not limited to the exact order shown in FIG. 3. Some of the steps may be carried out at the same time or may be carried out in a different order. For example, the fan 16 may be detachably connected to the fan speed control device 10 at any point without impacting the set-up process of the fan speed control device, and/or the configuration settings data may be received by the data receiver module 26 before any external sensors are paired to the fan speed control device 10.

The power modulator 28 of the fan speed control device 10 is configured to, in use, control the fan speed of the fan 16 by modulating a supply of power to the fan 16 in response to the received sensor data.

More specifically, the power modulator 28 is configured to, in use, modify the fan speed of the fan 16 by modulating the supply of power to the fan 16, e.g. by controlling the voltage to the fan 16, in response to a change in parameter of the received sensor data. This effectively converts the mains power into a variable power source for the fan 16 and thereby enables the fan speed control device 10 to provide sensor-driven variable fan speed control of the fan 16. In the case of the heart rate sensor 24, the change in parameter may be an increase or a decrease in heart beats per minute. In the case of the exercise equipment sensor, the change in parameter may be an increase or a decrease in an exercise resistance level, user power or user power.

The fan speed control device 10 is therefore capable of autonomously increasing or decreasing the fan speed of the fan 16 in response to a change in parameter of the received sensor data.

Furthermore, the fan speed control device 10 is configured to take into consideration ambient temperature, which affect the cooling effect provided by the fan 16 to a user. The power modulator 28 is configured to, in use, control the fan speed of the fan 16 in response to ambient temperature data measured by the ambient temperature sensor 32. If the ambient temperature is high, then increased cooling is needed. If the ambient temperature is low, then decreased cooling is needed. For example, the power modulator 28 is configured to increase the fan speed of the fan 16 by 2% per ° C. above ambient temperature, e.g. 20° C.

When increasing and decreasing the fan speed of the fan 16, the power modulator 28 is configured to, in use, control the fan speed of the fan 16 by modulating the supply of power to the fan 16 so that the fan 16 is controlled to switch between a first fan speed and a different, second fan speed for a predetermined time duration. This may be used in, for example, an exercise regime that involves alternating exercise intervals and recovery periods. A moving average, e.g. an exponentially-weighted moving average, of the received sensor data may be used by the power modulator 28 to control the fan speed in response to changing sensor data over time, especially in response to changing user power data over time. This enables a smooth response of the fan 16.

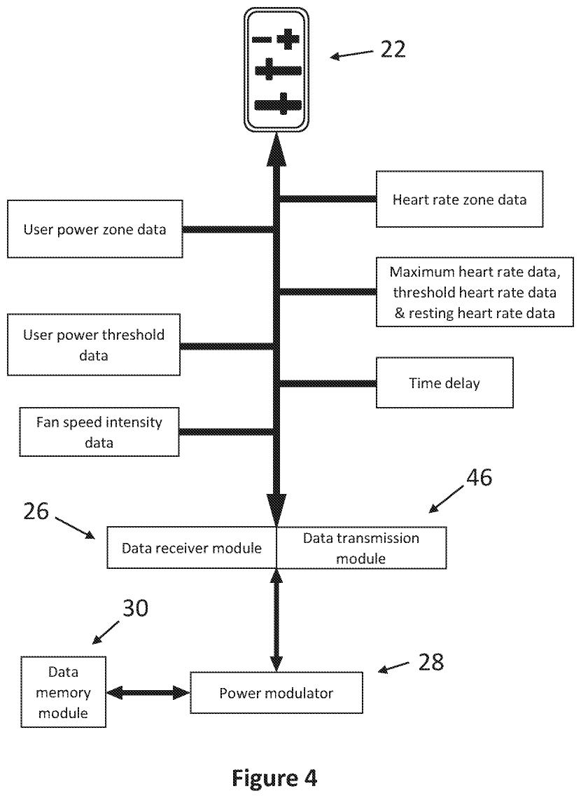

FIG. 4 shows in more detail how the data receiver module 26 is configured to, in use, receive configuration settings data that enable the power modulator 28 to control the fan speed of the fan 16 in response to the received sensor data in a way that is tailored to a user's cooling needs.

In an example, the configuration settings data comprises user heart rate zone data and user power zone data. The heart rate zone data may associate heart rate values with the user's training zones and/or corresponding fan speeds. The user power zone data may associate user power values with the user's training zones and/or corresponding fan speeds. The heart rate zone data and the user power zone data may be used in combination with visual indicators (e.g. light, electronic, colour or other visual indicators, which may be provided as part of the fan speed control device 10 or the mobile electronic device 22) to give the user a visual indication of their current effort level. The power modulator 28 may be configured to, in use, control the fan speed of the fan in response to the received sensor data based on the user's respective training zones. For instance, the fan speed to heart rate value/user power value may be calibrated by the user in order to tune the maximum, intermediate and/or minimum fan speeds in accordance with their needs. In one example, the power modulator 28 may be configured to control the fan speed to be at maximum speed when the heart rate values are at or above Zone 3 (aerobic exercise) and control the fan speed to be lower than the maximum speed, e.g. at 75% of the maximum speed, when the heart rate value is in or Zone 2 (endurance exercise).

In case that a user does not know how to accurately input their heart rate zone data and user power zone data, the configuration settings data also comprises maximum heart rate data, threshold heart rate data, resting heart rate data and threshold user power data. Each of the maximum heart rate data, the threshold heart rate data and the resting heart rate data may associate a heart rate value to a fan speed. The threshold user power data may associate a user power value to a fan speed. Similarly, the maximum heart rate data, threshold heart rate data, resting heart rate data and threshold user power data may be used in combination with visual indicators (e.g. light, electronic, colour or other visual indicators, which may be provided as part of the fan speed control device 10 or the mobile electronic device 22) to give the user a visual indication of their current effort level. The power modulator 28 may be configured to, in use, control the fan speed of the fan in response to the received sensor data based on the heart rate values and user power values that were associated with particular fan speeds. For instance, the fan speed to heart rate value/user power value may be calibrated by the user in order to tune the maximum, intermediate and/or minimum fan speeds in accordance with their needs.

In addition, the configuration settings data may comprise time delay data that includes a time delay for delaying the power modulator's control of the fan speed of the fan 16 by modulating the supply of power to the fan 16 in response to the received sensor data. It may be possible to disable the time delay data. Also, the time delay may be based on the duration and intensity of an exercise session or a previous exercise session. Further, the time delay may be set to have a capped value that cannot be exceeded.

The configuration settings data may comprise fan speed intensity data that includes a multiplier value for amplifying or de-amplifying the fan speed of the fan. The multiplier value may be used, together with the user power threshold data (such as functional threshold power), to adjust the relationship between a change in parameter of the exercise data and the extent of the modification of the fan speed of the fan 16 controlled by the power modulator 28.

Incorporation of user-inputted hysteresis and fan speed intensity into the fan speed control enables a more customised operation of the fan 16 to suit the user's individual cooling needs.

In other embodiments, the configuration settings data may comprise any settings that affect the control of the fan, such as the ambient temperature at which the fan speed of the fan should be increased or such as the maximum or minimum time duration of a specific fan speed (e.g. a maximum or minimum fan speed).

The fan speed control device 10 further comprises a data transmission module 46 capable of transferring configuration settings data and any other relevant information (such as for use in analytics) of the fan speed control device 10 to the mobile electronic device 22. In other embodiments, the data transmission module 46 may be the same as or integral with the data receiver module 26.

The listing or discussion of an apparently prior-published document or apparently prior-published information in this specification should not necessarily be taken as an acknowledgement that the document or information is part of the state of the art or is common general knowledge.

Preferences and options for a given aspect, feature or parameter of the invention should, unless the context indicates otherwise, be regarded as having been disclosed in combination with any and all preferences and options for all other aspects, features and parameters of the invention.

1. A fan speed control device for controlling a fan speed of a fan, the fan speed control device comprising:
a power input configured for connection to a power source to receive power from the power source;
a power output configured for detachable connection to the fan to supply power to the fan;
a data receiver module configured to, in use, receive sensor data from a sensor; and
a power modulator configured to, in use, control the fan speed of the fan by modulating a supply of power to the fan in response to the received sensor data.

2. A fan speed control device according to claim 1 wherein the power output is configured for detachable connection to a power connector of the fan.

3. A fan speed control device according to claim 2 wherein the power output includes a socket for detachably receiving a power connector of the fan.

4. A fan speed control device according to claim 1 any one of the wherein the power input is configured for connection to a mains power source.

5. A fan speed control device according to claim 1 any one of the further comprising a housing that houses at least the data receiver module and the power modulator.

6. A fan speed control device according to claim 1, wherein the sensor data comprises heart rate data, and the data receiver module is configured to, in use, receive the heart rate data from a heart rate sensor.

7. A fan speed control device according to claim 1, wherein the sensor data comprises temperature data, and the data receiver module is configured to, in use, receive the temperature data from a temperature sensor.

8. A fan speed control device according to claim 1, wherein the sensor data comprises exercise data, and the data receiver module is configured to, in use, receive the exercise data from an exercise sensor.

9. A fan speed control device according to claim 1, wherein the sensor data comprises exercise data, and the data receiver module is configured to, in use, receive the exercise data from an exercise equipment sensor.

10. (canceled)

11. A fan speed control device according to claim 1 further comprising an ambient temperature sensor, and wherein the power modulator is configured to, in use, control the fan speed of the fan in response to ambient temperature data measured by the ambient temperature sensor.

12. A fan speed control device according to claim 1 wherein the data receiver module is configured to, in use, receive configuration settings data, and the power modulator is configured to, in use, control the fan speed of the fan by modulating the supply of power to the fan in accordance with the configuration settings data.

13. A fan speed control device according to claim 1 further comprising a data memory module configured to, in use, store configuration settings data of the power modulator.

14. (canceled)

15. A fan speed control device according to claim 12 wherein the configuration settings data includes at least one of user heart rate zone data, maximum heart rate data, threshold heart rate data and resting heart rate data.

16. A fan speed control device according to claim 12 wherein the configuration settings data includes at least one of user power zone data and threshold user power data.

17. A fan speed control device according to claim 12 wherein the configuration settings data includes time delay data, and the time delay data includes a time delay for delaying the power modulator's control of the fan speed of the fan by modulating the supply of power to the fan in response to the received sensor data.

18. A fan speed control device according to claim 12 wherein the configuration settings data includes fan speed intensity data, and the fan intensity data includes a multiplier value for amplifying or de-amplifying the fan speed of the fan controlled by the power modulator by modulating the supply of power to the fan in response to the received sensor data.

19. A fan speed control device according to claim 12 wherein the power modulator is configured to, in use, modify the fan speed of the fan by modulating the supply of power to the fan in response to a change in parameter of the received sensor data.

20. A fan speed control device according to claim 12 wherein the power modulator is configured to, in use, control the fan speed of the fan by modulating the supply of power to the fan so that the fan is controlled to switch between a first fan speed and a different, second fan speed for a predetermined time duration.

21. A fan speed control device according to claim 12 wherein the data receiver module is configured to, in use, receive the sensor data from the sensor via wireless communication.

22. (canceled)

23. An apparatus comprising:
a fan speed control device according to claim 1; and
a user input device configured to be in communication with the data receiver module of the fan speed control device, wherein the user input device is configured to permit user input of configuration settings data for transmission to the data receiver module.

24. (canceled)
